(19) United States
(12) Patent Application Publication
(10) Pub. No.: US 2017/0176373 A1
(43) Pub. Date: Jun. 22, 2017

(54) MEASURING DEVICE, MEASURING METHOD, AND SUPPLY DEVICE

(71) Applicant: Seiko Epson Corporation, Tokyo (JP)

(72) Inventor: Makoto KATASE, Azumino (JP)

(21) Appl. No.: 15/358,663

(22) Filed: Nov. 22, 2016

(30) Foreign Application Priority Data
Dec. 22, 2015 (JP) 2015-249401

(51) Int. Cl. G01N 27/327

(52) U.S. Cl. CPC G01N 27/3274; G01N 27/3272

(57) ABSTRACT

A measuring device includes a detecting unit including a conductive layer (a current measuring unit) configured to measure a value of an electric current that fluctuates according to the concentration of a measurement target substance, a temperature sensor (a temperature measuring unit) configured to measure an environmental temperature of an environment in which the conductive layer is placed, a storing unit configured to store, as a plurality of combinations, analytical curves of current fluctuation width due to a shift (Δt) of the environmental temperature from a set temperature and the concentration of the measurement target substance, and a computing unit configured to derive the concentration of the measurement target substance from the shift (Δt) of the environmental temperature from the set temperature, the current value, and the analytical curves.

### BACKGROUND

1. Technical Field

The present invention relates to a measuring device, a measuring method, and a supply device.

2. Related Art

According to the rising health concern in recent years, a blood sugar level, a lactic acid level, concentration of antibody, an enzyme level, and the like in body fluid such as blood, interstitial fluid, saliva, and sweat in a specific individual are measured over time to carry out health care.

For example, for diabetics, measurement (monitoring) over time of blood sugar levels is particularly important.

The diabetics are classified into a I type and a II type according to their symptoms. In both the types, insulin secretion from the pancreas is abnormal and, therefore, internal organs cannot normally take in glucose, a metabolic error is caused, and weight decreases. Further, it is known that, when a high blood sugar level state is kept for a long period, serious complications such as “diabetic retinopathy”, “diabetic nephropathy”, “diabetic microangiopathy”, and “diabetic neuropathy” develop. For the purpose of preventing the development of such serious complications, in the present situation, a treatment method for administering insulin to a patient in the long-lasting high blood sugar level state through injection to maintain a blood sugar level within a normal range is adopted.

The I type diabetic has no insulin secretion because of a pancreatic disease. Therefore, blood sugar level measurement by blood sampling has to be performed several times a day (at least four times; before meals and before bedtime) to administer insulin. As timing of the administration, a blood sugar level is measured before a meal in order to suppress an excessive increase in a blood sugar level after the meal, a calorie of a meal amount is calculated to determine a dosage of the insulin, and the insulin is injected and administered before the meal. A symptom known as an increase in a blood sugar level is a symptom called “dawn phenomenon”. The blood sugar level increases in the dawn 8 to 10 hours after bedtime. However, In order to cope with this physiological phenomenon, the patient has to wake up once before dawn, perform blood sugar level measurement by blood sampling, and if, a blood sugar level is high, administer the insulin. Whereas a general healthy person can live daily life without worrying about a blood sugar level, the diabetic (in particular, the I type diabetic) is forced to live always worrying about a blood sugar level throughout the day.

In order to reduce such a burden in the life of the patient and a family supporting the patient, that is, improve the quality of life (QOL) of the patient and the family, in the present situation, there is a demand for development of an artificial pancreas or a device similar to the artificial pancreas. For the development of the artificial pancreas or the device, first, a blood sugar level needs to be measured and managed over time (continuously) and automatically.

For example, there has been proposed a device for embedding a blood sugar level sensor in a body (a subcutaneous tissue) and monitoring glucose concentration in interstitial fluid of a patient for a long period, a so-called continuous glucose monitor (CGM) device that makes use of enzyme reaction.

As a basic principle of glucose quantitative measurement using the enzyme reaction, when glucose and oxygen are present near an enzyme (e.g., glucose oxidase) under the presence of the enzyme, gluconic acid and hydrogen peroxide are generated. An amount of the hydrogen peroxide can be quantified by measuring a current value generated by electrolyzing the generated hydrogen peroxide. Therefore, it is possible to calculate an amount of glucose on the basis of the amount of the hydrogen peroxide. By using such enzyme reaction, it is possible to continuously monitor a blood sugar level with the sensor embedded in the body.

In a measuring device (an analysis device) that makes use of such a basic principle of the glucose quantitative measurement, as explained above, the current value is measured and the glucose concentration in the interstitial fluid is measured on the basis of an assumption that the interstitial fluid has inherent glucose concentration corresponding to the obtained current value.

However, the activity of the enzyme changes according to a reaction temperature, that is, the temperature of the interstitial fluid. The temperature of the interstitial fluid of the patient also greatly changes according to a change of a living environment such as a room temperature and a change of living activities such as bathing, exercise, and sleep. Therefore, even if the glucose concentration in the interstitial fluid is the same, the current value measured by the measuring device changes according to the temperature change of the interstitial fluid of the patient. As a result, an error occurs in the glucose concentration calculated on the basis of the current value.

Therefore, there has been proposed to provide, in a measuring device, a temperature measuring unit that measures the temperature of interstitial fluid near a place where a current value is measured, correct the measured current value according to the measured temperature of the interstitial fluid to improve accuracy of glucose concentration to be calculated and provide a temperature adjusting unit that cools or heats the interstitial fluid near the place where the current value is measured and set the interstitial fluid to a predetermined temperature to improve the accuracy of the glucose concentration to be calculated (see, for example, JP-A-2011-167503 (Patent Literature 1)).

However, it cannot be said that the accuracy of the glucose concentration calculated on the basis of the measured current value is not sufficiently improved by the measuring device. There is a demand for development of a measuring device that can calculate glucose concentration at more excellent accuracy.

Note that such a problem also occurs in measuring devices that calculate measurement targets such as a lactic acid level, concentration of antibody, and an enzyme level in body fluid over time on the basis of a current value besides the measuring device that calculates the glucose concentration in the interstitial fluid over time on the basis of the measured current value.

### SUMMARY

An advantage of some aspects of the invention is to provide a measuring device, a measuring method, and a supply device that calculate concentration of a measurement target substance in body fluid over time on the basis of a measured current value, the measuring device, the measuring method, and the supply device being capable of measuring the concentration of the measurement target substance at more excellent accuracy even if the temperature of the body fluid near a place where the current value is measured fluctuates.

The advantage can be achieved by the following configurations.

A measuring device according to an aspect of the invention includes: a current measuring unit configured to measure a value of an electric current that fluctuates according to the concentration of a measurement target substance; a temperature measuring unit configured to measure an environmental temperature of an environment in which the current measuring unit is placed; a storing unit configured to store, as a plurality of combinations, analytical curves of current fluctuation width due to a shift (Δt) of the environmental temperature from a set temperature and the concentration of the measurement target substance; and a computing unit configured to derive the concentration of the measurement target substance from the shift (Δt) of the environmental temperature from the set temperature, the current value, and the analytical curves.

With this configuration, it is possible to measure the concentration of the measurement target substance at more excellent accuracy even if the temperature of body fluid near a place where the current value is measured fluctuates.

In the measuring device according to the aspect, it is preferable that the measuring device further includes a temperature adjusting unit configured to adjust the environmental temperature.

With this configuration, since a change in the environmental temperature can be positively created, it is possible to measure the concentration of the measurement target substance more stably and in a shorter time.

In the measuring device according to the aspect, it is preferable that the plurality of combinations of the analytical curves are acquired according to a plurality of conditions for gradually increasing or reducing the environmental temperature.

By using the plurality of combinations of the analytical curves acquired according to the plurality of conditions, it is possible to calculate the concentration of the measurement target substance as concentration having more excellent accuracy.

In the measuring device according to the aspect, it is preferable that the measurement target substance is glucose, hydrogen peroxide is generated from the glucose by enzyme reaction, and the electric current is an electric current generated by decomposing the hydrogen peroxide.

With this configuration, it is possible to measure the concentration of the glucose at more excellent accuracy even if the temperature of the body fluid near the place where the current value is measured fluctuates.

A measuring method according to another aspect of the invention includes: measuring a value of an electric current that fluctuates according to the concentration of a measurement target substance; measuring an environmental temperature of an environment in which the current value is measured; and deriving the concentration of the measurement target substance from a plurality of combinations of analytical curves of current fluctuation width due to a shift (Δt) of the environmental temperature from a set temperature and the concentration of the measurement target substance, the environmental temperature, and the current value.

With this configuration, it is possible to measure the concentration of the measurement target substance at more excellent accuracy even if the temperature of body fluid near a place where the current value is measured fluctuates.

In the measuring method according to the aspect, it is preferable that the measuring method further includes adjusting the environmental temperature before the current measurement or after the current measurement.

With this configuration, since a change in the environmental temperature can be positively created, it is possible to measure the concentration of the measurement target substance more stably and in a shorter time.

In the measuring method according to the aspect, it is preferable that the plurality of combinations of the analytical curves are acquired according to a plurality of conditions for gradually increasing or reducing the environmental temperature.

By using the plurality of combinations of the analytical curves acquired according to the plurality of conditions, it is possible to calculate the concentration of the measurement target substance as concentration having more excellent accuracy.

In the measuring method according to the aspect, it is preferable that the measurement target substance is glucose, hydrogen peroxide is generated from the glucose by enzyme reaction, and the electric current is an electric current generated by decomposing the hydrogen peroxide.

With this configuration, it is possible to measure the concentration of the glucose at more excellent accuracy even if the temperature of the body fluid near the place where the current value is measured fluctuates.

A supply device according to still another aspect of the invention includes: a current measuring unit configured to measure a value of an electric current that fluctuates according to the concentration of a measurement target substance; a temperature measuring unit configured to measure an environmental temperature of an environment in which the current measuring unit is placed; a storing unit configured to store, as a plurality of combinations, analytical curves of current fluctuation width due to a shift (Δt) of the environmental temperature from a set temperature and the concentration of the measurement target substance; a computing unit configured to derive the concentration of the measurement target substance from the environmental temperature, the current value, and the analytical curves; and a chemical supplying unit configured to supply a chemical on the basis of the concentration of the measurement target substance.

With this configuration, it is possible to measure the concentration of the measurement target substance at more excellent accuracy even if the temperature of body fluid near a place where the current value is measured fluctuates. It is possible to supply the chemical at more excellent accuracy on the basis of the obtained concentration of the measurement target substance.

In the supply device according to the aspect, it is preferable that the supply device further includes a temperature adjusting unit configured to adjust the environmental temperature.

With this configuration, since a change in the environmental temperature can be positively created, it is possible to measure the concentration of the measurement target substance more stably and in a shorter time.

In the supply device according to the aspect, it is preferable that the plurality of combinations of the analytical curves are acquired according to a plurality of conditions for gradually increasing or reducing the environmental temperature.

By using the plurality of combinations of the analytical curves acquired according to the plurality of conditions, it is possible to calculate the concentration of the measurement target substance as concentration having more excellent accuracy.

In the supply device according to the aspect, it is preferable that the measurement target substance is glucose, hydrogen peroxide is generated from the glucose by enzyme reaction, the electric current is an electric current generated by decomposing the hydrogen peroxide, and the chemical is insulin.

With this configuration, it is possible to measure the concentration of the glucose at more excellent accuracy even if the temperature of the body fluid near the place where the current value is measured fluctuates. It is possible to supply the insulin at more excellent accuracy on the basis of the obtained glucose concentration.

### BRIEF DESCRIPTION OF THE DRAWINGS

The invention will be described with reference to the accompanying drawings, wherein like numbers reference like elements.

FIG. 1 is a perspective view schematically showing a first embodiment of a measuring device of the invention and shows a state in which a detachable unit included in a detection element included in the measuring device is attached to a main body unit.

FIG. 2 is a perspective view schematically showing the first embodiment of the measuring device of the invention and shows a state in which the detachable unit included in the detection element included in the measuring device is detached from main body unit.

FIG. 3 is a side view showing a state in which a detection element included in the first embodiment of the measuring device of the invention is attached to the skin.

FIG. 4 is an enlarged longitudinal sectional view showing a cannula included in the detection element shown in FIG. 3.

FIG. 5 is a plan view showing a detecting unit included in the detection element shown in FIG. 3.

FIG. 6 is a longitudinal sectional view showing the detection unit included in the detection element shown in FIG. 3.

FIG. 7 is a block diagram showing a circuit configuration of the measuring device shown in FIG. 1.

FIG. 8 is a graph showing a relation between a current value measured in a conductive layer when the temperature of interstitial fluid near the conductive layer cyclically fluctuates 0.2° C. and time.

FIG. 9 is a graph showing a relation between a current value measure in the conductive layer when the temperature of the interstitial fluid near the conductive layer is fixed and time.

FIG. 10 is a graph showing a relation between a current value measured in the conductive layer and glucose concentration in the interstitial fluid at different temperatures (T1<T2) of the interstitial fluid near the conductive layer.

FIG. 11 is an analytical curve (a graph) showing a relation between glucose concentration and current fluctuation width at the time when an environmental temperature changes from an initial set temperature to a present environmental temperature at the magnitude of a shift (Δt).

FIG. 12 is a flowchart for explaining a method of measuring glucose concentration using the measuring device shown in FIG. 1.

FIG. 13 is a plan view showing a detecting unit included in a detection element included in a second embodiment of the measuring device of the invention.

FIG. 14 is a flowchart for explaining a first method of measuring glucose concentration using the measuring device shown in FIG. 13.

FIG. 15 is a flowchart for explaining a second method of measuring glucose concentration using the measuring device shown in FIG. 13.

FIG. 16 is a flowchart for explaining a third method of measuring glucose concentration using the measuring device shown in FIG. 13.

FIG. 17 is a graph showing a relation between the temperature of interstitial fluid at the time when glucose concentration is measured using the third method shown in FIG. 16 and time.

FIG. 18 is a perspective view schematically showing an embodiment in which a supply device according to the invention is applied to an insulin pump and shows a state in which a detachable unit included in a detection element included in the insulin pump is detached from a main body unit.

### DESCRIPTION OF EXEMPLARY EMBODIMENTS

A measuring device, a measuring method, and a supply device according to the invention are explained in detail below with reference to embodiments shown in the figures.

Note that, in the embodiment, an example is explained in which the measuring device according to the invention is applied to a continuous glucose monitor (CGM) device that monitors glucose concentration in interstitial fluid continuously (over time) for a long period on the basis of a current value measured in the interstitial fluid.

### Measuring Device

### First Embodiment

First, a measuring device according to the invention is explained.

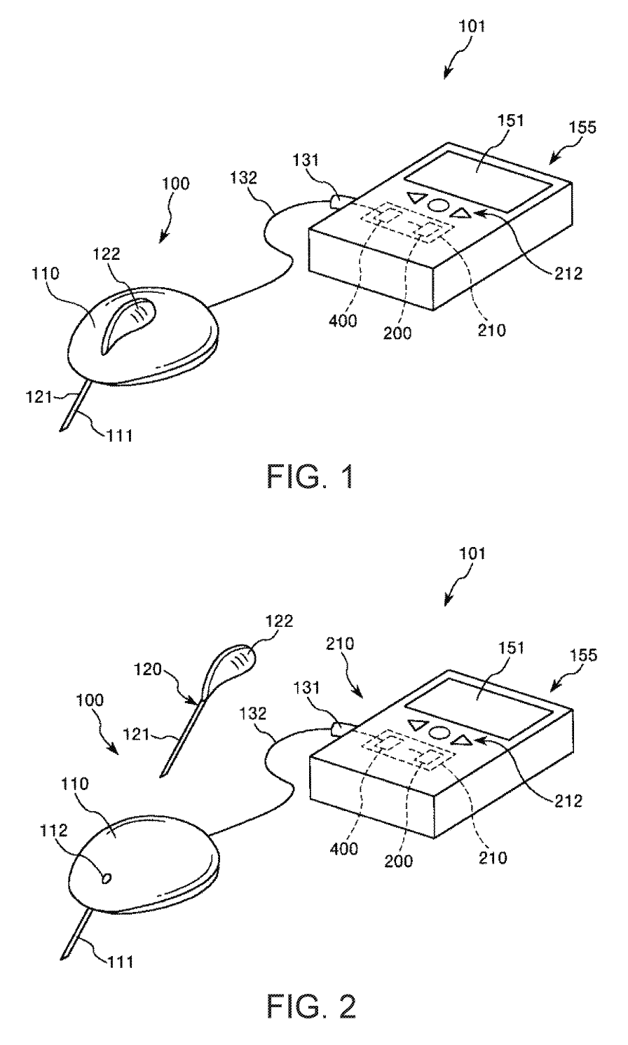

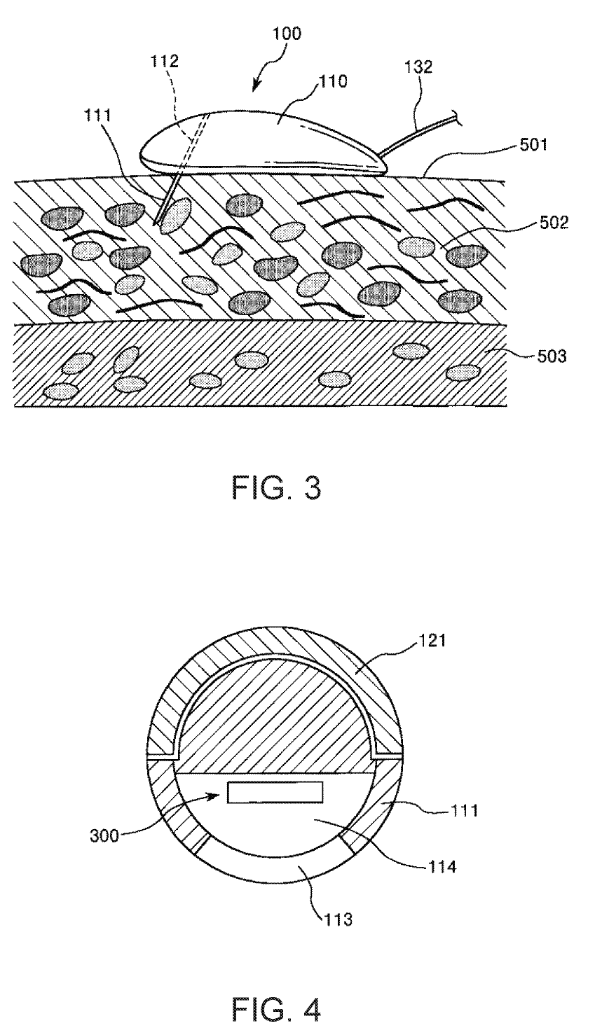

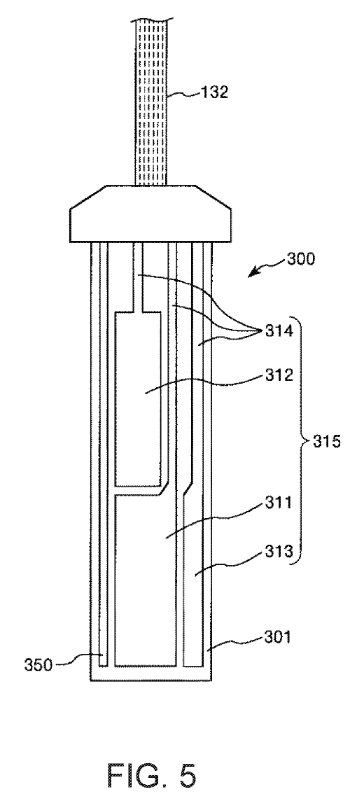

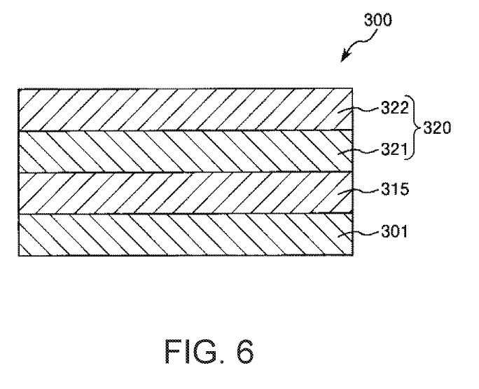

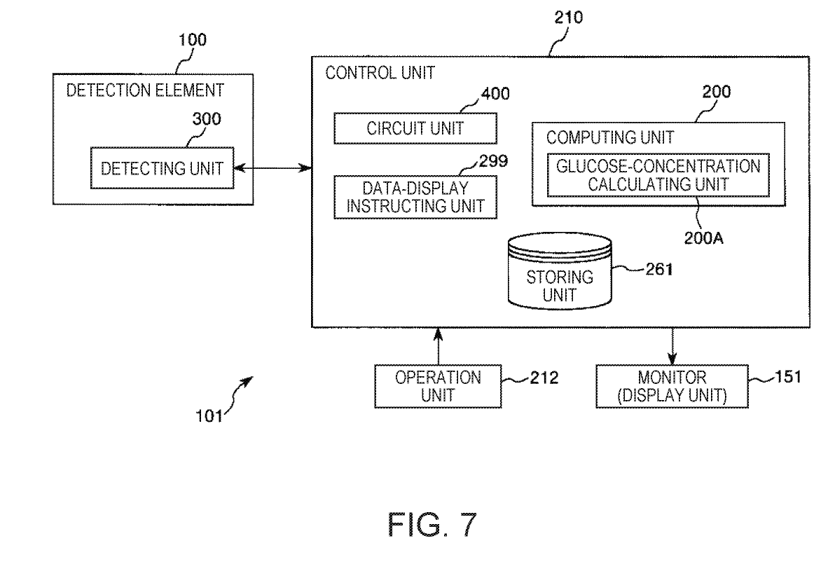

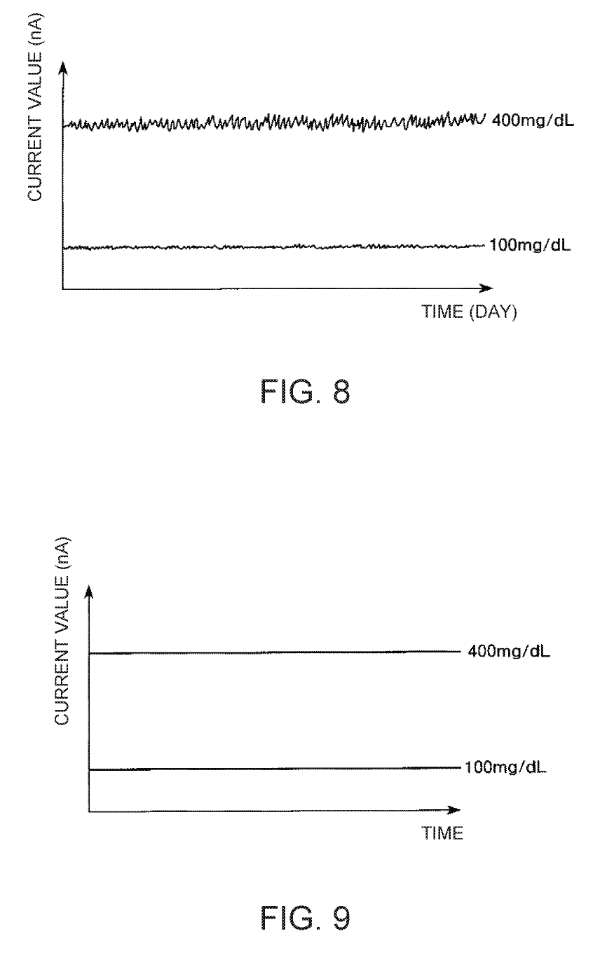

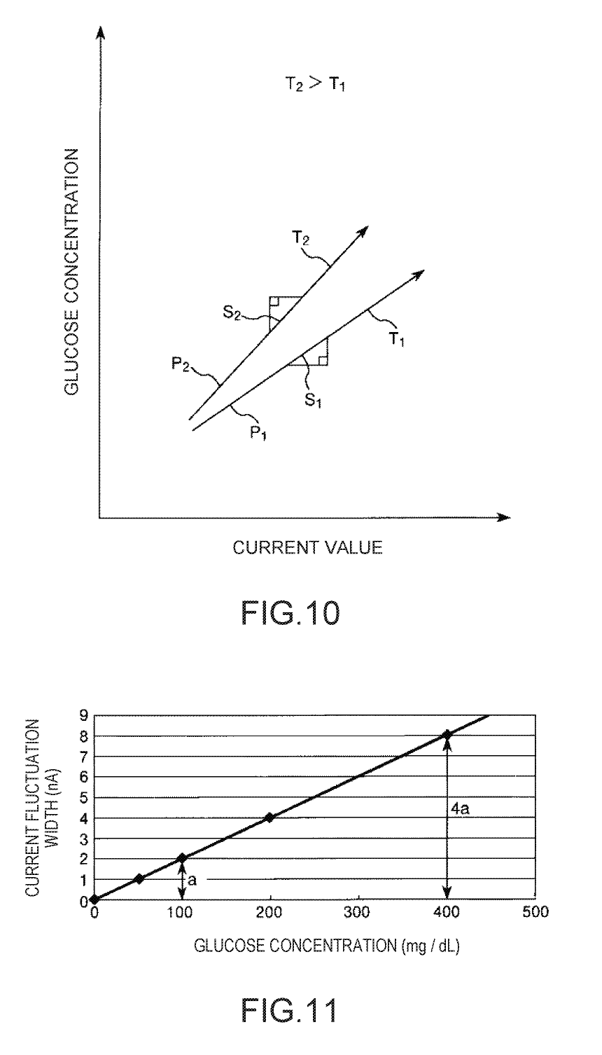

FIG. 1 is a perspective view schematically showing a first embodiment of a measuring device according to the invention and shows a state in which a detachable unit included in a detection element included in the measuring device is attached to a main body unit. FIG. 2 is a perspective view schematically showing the first embodiment of the measuring device according to the invention and shows a state in which the detachable unit included in the detection element included in the measuring device is detached from main body unit. FIG. 3 is a side view showing a state in which a detection element included in the first embodiment of the measuring device according to the invention is attached to the skin. FIG. 4 is an enlarged longitudinal sectional view showing a cannula included in the detection element shown in FIG. 3. FIG. 5 is a plan view showing a detecting unit included in the detection element shown in FIG. 3. FIG. 6 is a longitudinal sectional view showing the detection unit included in the detection element shown in FIG. 3. FIG. 7 is a block diagram showing a circuit configuration of the measuring device shown in FIG. 1. FIG. 8 is a graph showing a relation between a current value measured in a conductive layer when the temperature of interstitial fluid near the conductive layer cyclically fluctuates 0.2° C. and time. FIG. 9 is a graph showing a relation between a current value measure in the conductive layer when the temperature of the interstitial fluid near the conductive layer is fixed and time. FIG. 10 is a graph showing a relation between a current value measured in the conductive layer and glucose concentration in the interstitial fluid at different temperatures (T1<T2) of the interstitial fluid near the conductive layer. FIG. 11 is an analytical curve (a graph) showing a relation between glucose concentration and current fluctuation width at the time when an environmental temperature changes from an initial set temperature to a present environmental temperature at the magnitude of a shift (Δt). Note that, in the following explanation, in FIGS. 3, 4, and 6, an upper side is referred to “upper” and a lower side is referred to as “lower”. In FIG. 5, a near side on the paper surface is referred to “upper” and a depth side on the paper surface is referred to as “lower”.

As shown in FIGS. 1 and 2, a measuring device 101 is used with a detection element 100 connected thereto. The measuring device 101 includes the detection element 100, a control unit 210 including a circuit unit 400 for obtaining a current value based on glucose concentration in the detection element 100 and a computing unit 200 that calculates the glucose concentration on the basis of the obtained current value, a monitor (a display unit) 151 that displays a measurement value obtained by computing in the control unit 210, an operation unit 212 for performing kinds of operation such as an input, a connector 131 that connects the detection element 100 to the control unit 210, and a wire 132 that connects the detection element 100 and the connector 131. Note that, in the embodiment, the control unit 210, the monitor 151, the operation unit 212, and the connector 131 included in the measuring device 101 are provided in a main body 155.

As shown in FIGS. 1 to 4, the detection element 100 includes a main body unit 110 including a cannula 111 inserted into a subcutaneous tissue 502 and a detachable unit 120 detachably attachable to the main body unit 110 and including a needle section 121 on the distal end side.

The detachable unit 120 includes a gripping section 122 located on the proximal end side and the needle section 121 located on the distal end side. The detachable unit 120 is attached to the main body unit 110 by inserting the needle section 121 through a through-hole 112 included in the main body unit 110 (see FIG. 1) and can be detached from the main body unit 110 by pulling out the needle section 121 in a state in which the gripping section 122 is gripped (see FIG. 2).

The needle section (an inserting needle) 121 has a sharp tip and is formed in a semi-cylindrical shape as an entire shape. When the detachable unit 120 is attached to the main body unit 110, the needle section 121 pierces through the through-hole 112 and projects from the lower surface of the main body unit 110 to surround a part of a side surface of the cannula 111, as shown in FIG. 4. Consequently, the needle section 121 fits with the cannula 111. Therefore, when the main body unit 110 is attached to a cuticle 501, the needle section 121 pierces the cuticle 501. At this point, the cannula 111 surrounded by the needle section 121 also pierces the cuticle 501 and is inserted into the subcutaneous tissue 502 together with the needle section 121. After the insertion of the needle section 121 involving the cannula 111 into the subcutaneous tissue 502, by gripping the gripping section 122 and detaching the detachable unit 120 from the main body unit 110, it is possible to remove (pull out) the needle section 121 from the subcutaneous tissue 502 in a state in which the cannula 111 is inserted (left) in the subcutaneous tissue 502. In this way, the detachable unit 120 (the needle section 121) is used as a guiding member for disposing the cannula 111 projecting from the main body unit 110 on the subcutaneous tissue 502 in a transcutaneous manner when the main body unit 110 is attached to the cuticle 501.

The main body unit 110 is formed in a dome shape as an entire shape and includes the cannula 111 projecting from the lower surface of the main body unit 110. The main body unit 110 includes an adhesive layer on the lower surface. The main body unit 110 is attached (fixed) by setting the lower surface in contact with the cuticle 501. At this point, the cannula 111 is disposed on the subcutaneous tissue 502 by the guiding of the needle section 121.

The cannula 111 is formed in a cylindrical shape as an entire shape and includes a hollow section 114 configured by a communication hole (a through-hole) that communicates from the proximal end to the distal end of the cannula 111 and a window section 113 that opens the hollow section 114 to the outer side of the cannula 111.

A detection unit 300 included in the main body unit 110 is provided in the hollow section 114. When blood shifts from a blood vessel 503 to the subcutaneous tissue 502, interstitial fluid included in the blood comes into contact with the detection unit 300 via the window section 113. Therefore, glucose in the interstitial fluid is detected by the detection unit 300. By attaching the main body unit 110 to the cuticle 501, it is possible to dispose the cannula 111 on the subcutaneous tissue 502 for a long period. Therefore, it is possible to continuously perform the detection of the glucose in the interstitial fluid. That is, the main body unit 110 (the detection element 100) is used in a CGMS (continuous glucose monitoring system) that continuously observes glucose concentration in the interstitial fluid.

The detection of glucose by the detection unit 300 is performed using a principle explained below.

When glucose and oxygen are present near an enzyme (e.g., glucose oxidase) under the presence of the enzyme, gluconic acid and hydrogen peroxide are generated by enzyme reaction as indicated by Formula (1) described below. An amount of the hydrogen peroxide can be quantified by measuring, between a working electrode and a counter electrode, a current value generated by applying a voltage (e.g., 600 mV) to the generated hydrogen peroxide and electrolyzing the generated hydrogen peroxide. Therefore, it is possible to calculate an amount of glucose on the basis of the quantified amount of the hydrogen peroxide.

Note that, in the electrolysis of the hydrogen peroxide, on the working electrode (anode) side, as indicated by Formula (2) described below, proton, oxygen, and an electron are generated by the electrolysis of the hydrogen peroxide. On the counter electrode (cathode) side, as indicated by Formula (3) described below, the electron supplied from the working electrode and oxygen and water present near the electrode react, whereby a hydroxide ion is generated.

Enzyme reaction: glucose+O₂+H₂O→gluconic acid+H₂O₂ (1)

Working electrode: H₂O₂→O₂+2H⁺+2e⁻ (2)

Counter electrode: O₂+H₂O+4e⁻→4OH⁻ (3)

The detection unit 300 that detects glucose using such a principle is explained in detail below.

The detection unit 300 includes, as shown in FIGS. 5 and 6, a substrate 301, a conductive layer (an electrode) 315, a sensing layer (an enzyme layer) 320, and a temperature sensor 350.

The substrate (a base substrate) 301 supports sections (in this embodiment, the conductive layer 315 and the sensing layer 320) configuring the detection unit 300.

As a constituent material of the substrate 301, various materials can be used without being particularly limited as long as the materials do not chemically react with the atmosphere, water, body fluid, blood, and interstitial fluid and are stable. Specifically, examples of the constituent material include inorganic materials such as glass and SUS and resin materials such as amorphous polyarylate (PAR), polysulfone (PSF), polyethersulfone (PES), polyphenylene sulfide (PPS), polyether ether ketone (PEEK/alias: aromatic polyether ketone), polyimide (PI), polyetherimide (PEI), fluorocarbon polymer, polyamide (PA) including nylon and amide, and polyester like polyethylene terephthalate (PET). One kind of these materials can be used or two or more kinds of these materials can be used in combination.

The conductive layer (an electrode layer) 315 detects an electron generated by electrolyzing hydrogen peroxide generated in the sensing layer 320 explained below and measures the detected electron as a current value. That is, the conductive layer 315 configures a current measuring unit that measures the current value of the hydrogen peroxide and the current value that fluctuate according to the concentration of glucose (a measurement target substance).

The conductive layer 315 is formed on the substrate 301 and includes a working electrode 311, a counter electrode 312, a reference electrode 313, and a wire 314.

The electrodes 311, 312, and 313 are respectively electrically connected to the control unit 210 including the circuit unit 400 and the computing unit 200 via the wire 314, the wire 132, and the connector 131 independently from one another. Consequently, the electron generated in the sensing layer 320 is transmitted to the circuit unit 400 included in the control unit 210 via the wires 314 and 132 as a value of an electric current flowing between the electrodes 311 and 312 (in the conductive layer 315). Further, the current value is analyzed by the computing unit 200 included in the control unit 210, whereby glucose concentration in interstitial fluid is calculated as a measurement value. The measurement value (glucose concentration) is displayed on the monitor 151. The glucose concentration is continuously informed to a wearer.

Constituent materials of the electors 311, 312, and 313 are not particularly limited as long as the constituent materials can be used as an enzyme electrode. Examples of the constituent materials respectively include a metal material such as gold, silver, or platinum or an alloy including gold, silver, and platinum, a metal oxide material such as ITO, and a carbon material such as carbon (graphite).

Note that films of the electrodes 311, 312, and 313 can be formed by a sputtering method, a plating method, or a vacuum heating deposition method when the electrodes 311, 312, and 313 are formed of platinum, gold, or an alloy of platinum and gold. When the electrodes 311, 312, and 313 are formed of carbon graphite, the film formation can be realized by mixing the carbon graphite in a binder dissolved in an appropriate solvent and applying the carbon graphite.

The temperature sensor 350 measures temperature in interstitial fluid near the conductive layer 315. The temperature sensor 350 measures a subcutaneous temperature (the temperature of the interstitial fluid) of a measurer at the time when a current value is measured in the conductive layer 315. That is, the temperature sensor 350 configures a temperature measuring unit that measures an environmental temperature of an environment in which the conductive layer 315 (a current measuring unit) is placed.

Like the conductive layer 315, the temperature sensor 350 is formed on the substrate 301. In this embodiment, the temperature sensor 350 is provided near and on the lateral side of, in particular, the working electrode 311 and the counter electrode 312 in the conductive layer 315. The temperature sensor 350 is covered with the sensing layer 320 together with the conductive layer 315.

The temperature sensor 350 is electrically connected to the circuit unit 400 including the computing unit 200 via the wire 132 and the connector 131. Consequently, the temperature sensor 350 measures temperature in the interstitial fluid near the conductive layer 315 at the time when a value of an electric current flowing between the electrodes 311 and 312 is measured. By performing correction of the current value on the basis of the temperature, accuracy of glucose concentration calculated on the basis of the current value is improved. Details of the correction of the current value are explained below.

As the temperature sensor 350, for example, besides a thermistor, publicly-known various sensors can be used.

The sensing layer 320 is stacked and formed on the conductive layer 315 and the temperature sensor 350. The sensing layer 320 generates, through enzyme reaction, hydrogen peroxide from glucose penetrating from the interstitial fluid in contact with the upper surface of the sensing layer 320 and supplies the hydrogen peroxide to the conductive layer 315. The sensing layer 320 senses the glucose through enzyme reaction for generating the hydrogen peroxide from the glucose.

In this embodiment, the sensing layer 320 includes an analyte sensing layer 321 and an analyte adjustment layer 322. The sensing layer 320 is a stacked body obtained by stacking the analyte sensing layer 321 and the analyte adjustment layer 322 from the conductive layer 315 side in this order. These layers are explained below.

The analyte sensing layer (an enzyme layer) 321 is formed to cover the working electrode 311, the counter electrode 312, the reference electrode 313, and the temperature sensor 350. The analyte sensing layer 321 generates, through enzyme reaction, hydrogen peroxide from the glucose penetrating via the analyte adjustment layer 322. The analyte sensing layer 321 supplies the generated hydrogen peroxide to the conductive layer 315.

The analyte sensing layer 321 is a layer including an enzyme. Since the detection element 100 detects (senses) the glucose in the interstitial fluid as explained above, glucose oxidase (GOD) is desirably used as the enzyme. With the glucose oxidase, the enzyme reaction represented by Formula (1) described above can be advanced with excellent activity. Therefore, it is possible to surely generate the hydrogen peroxide from the glucose under the presence of O₂ and H₂O.

The analyte sensing layer 321 includes, besides the enzyme, a resin material for the purpose of retaining the enzyme in the analyte sensing layer 321.

The resin material is not particularly limited. However, methylcellulose (MC), acetylcellulose (cellulose acetate), polyvinylpyrrolidone (PVP), polyvinyl alcohol, polyvinyl alcohol-polyvinyl acetate copolymer (PVA-PVAc), and the like are desirably used. One kinds of these resin materials can be used or two or more kinds of these resin materials can be used in combination. By using these resin materials, it is possible to retain the enzyme in the analyte sensing layer 321 and suppress the enzyme from moving to the outside of the analyte sensing layer 321.

Further, the analyte sensing layer 321 may include albumin and a phosphate buffer material besides a binder or a hardener.

Examples of the binder or the hardener include a material including two or more functional groups such as aldehyde or isocyanate in a molecule. Since the binder or the hardener is included in the analyte sensing layer 321, the analyte sensing layer 321 can retain an enzyme in the analyte sensing layer 321 at excellent retention.

Examples of the binder or the hardener specifically include glutaraldehyde, toluene diisocyanate, and isophorone diisocyanate. One kind of these materials can be used or two or more kinds of these materials can be used in combination. Examples of the binder or the hardener that makes use of UV hardenability include a poly(vinylalcohol)-styrylpyridinium compound (PVA-SbQ).

Note that the analyte sensing layer 321 including the binder or the hardener can be obtained by hardening a resin composition obtained by mixing the binder or the hardener, a resin material including, at an end, a functional group that can be combined with a functional group included in the binder or the hardener, specifically, a hydroxyl group, an amino group, an epoxy group, or the like, and an enzyme.

Further, when the poly(vinylalcohol)-styrylpyridinium compound (PVA-SbQ) is used as the binder or the hardener that makes use of the UV hardenability, the analyte sensing layer 321 can also be configured by a hardened object obtained by hardening a resin composition containing the PVA-SbQ and an enzyme without adding the resin material including the functional group at the end. In this case, in the analyte sensing layer 321, the enzyme is retained in a porous body formed of the PVA-SbQ. It is possible to smoothly take interstitial fluid penetrating from the analyte adjustment layer 322 side into the analyte sensing layer 321. It is possible to increase a contact opportunity of glucose included in the interstitial fluid and the enzyme. It is possible to smoothly advance the enzyme reaction represented by Formula (1) described above. Therefore, it is possible to surely generate hydrogen peroxide from the glucose under the presence of O₂ and H₂O. Since the enzyme can be firmly retained in the porous body formed of the PVA-SbQ, it is possible to accurately suppress or prevent the enzyme from shifting to the analyte adjustment layer 322 side.

Examples of the albumin include human albumin and bovine albumin. Since the albumin is included in the analyte sensing layer 321, it is possible to achieve protection and stabilization of the enzyme.

Average thickness of the analyte sensing layer 321 is not particularly limited. However, the average thickness is desirably approximately 0.1 μm or more and 10 μm or less and more desirably approximately 0.5 μm or more and 5.0 μm or less. Consequently, it is possible to smoothly generate hydrogen peroxide through enzyme reaction of the glucose penetrating from the analyte adjustment layer 322 side and the enzyme retained in the analyte sensing layer 321. It is possible to smoothly supply the generated hydrogen peroxide to the conductive layer 315.

The analyte adjustment layer 322 is stacked on the upper side of the analyte sensing layer 321. The analyte adjustment layer 322 exhibits a function of causing glucose to permeate and causing the glucose to smoothly penetrate to the analyte sensing layer 321 while suppressing or preventing the analyte sensing layer 321 from coming into contact with a measurement target (interstitial fluid and blood). Further, the analyte adjustment layer 322 also exhibits a function of a blocking layer that prevents the enzyme retained in the analyte sensing layer 321 from leaking to the interstitial fluid side.

The analyte adjustment layer 322 having such functions desirably can cause the enzyme to permeate (penetrate) more than the glucose. Consequently, in the detection of the glucose using Formulas (1) to (3) described above, it is possible to accurately suppress or prevent a measurement value of the glucose from apparently decreasing because of insufficiency of the enzyme. That is, it is possible to achieve improvement of detection accuracy of a glucose measurement value.

The analyte adjustment layer 322 is not particularly limited. However, for example, a layer formed by generating urethane bond and constructing a bridge structure using a crosslinking agent such as an isocyanate compound and polyethylene glycol (PEG), polypropylene glycol (PPG), acrylic acid 4-hydroxybutyl, or the like, which are polymers having a terminal hydroxyl group, alone or as a mixture. Consequently, it is possible to more conspicuously exhibit the function of the analyte adjustment layer 322.

Besides, a layer formed by aminopropyl polysiloxane or the like in which urea resin is formed by using isocyanate and an amino group can be used. Further, a layer formed of siloxane resin such as polydimethylsiloxane can also be used.

Average thickness of the analyte adjustment layer 322 is not particularly limited. However, the average thickness is desirably approximately 0.1 μm or more and 10 μm or less and more desirably approximately 0.5 μm or more and 5.0 μm or less. Consequently, it is possible to cause glucose to smoothly permeate into the analyte adjustment layer 322. It is possible to accurately suppress or prevent the enzyme retained in the analyte sensing layer 321 from leaking to the interstitial fluid side.

Note that the sensing layer 320 may include other layers besides the analyte sensing layer 321 and the analyte adjustment layer 322. Examples of such layers include a noise removing layer stacked on the lower side of the analyte sensing layer 321 and an intermediate layer formed between the analyte sensing layer 321 and the analyte adjustment layer 322.

The noise removing layer is provided to inhibit deterioration in detection sensitivity of a glucose measurement value that is caused by a compound of acetoaminophen, ascorbic acid, uric acid, and the like, which are likely to be included in interstitial fluid, permeating the analyte sensing layer 321 and reaching the conductive layer 315.

The intermediate layer is provided to exhibit a function of a barrier layer that prevents the enzyme from shifting to the analyte adjustment layer 322 side.

Note that, in this embodiment, in the detection unit 300, all of the working electrode 311, the counter electrode 312, the reference electrode 313, and the wire 314 included in the conductive layer 315 are covered with the analyte sensing layer 321. However, the detection unit 300 is not limited to such a configuration. The analyte sensing layer 321 may be selectively formed on the working electrode 311 and the counter electrode 312 or the analyte sensing layer 321 may be selectively formed on the working electrode 311.

The control unit 210 is provided in the main body 155 and configured by combining a CPU, a memory, and the like. The control unit 210 controls the operations of the units such as the detection element 100 and the monitor (the display unit) 151, that is, the operation of the entire measuring device 101.

The control unit 210 includes, as shown in FIG. 7, a storing unit (storing means) 261, a circuit unit (a detecting-unit driving unit) 400, a data-display instructing unit 299, and a computing unit 200.

The storing unit 261 has stored therein an OS for controlling the entire operation of the measuring device 101, computer programs for realizing various functions, and various data including a plurality of analytical curves explained below. The storing unit 261 includes a temporary storage region in which a measured current value and the like are temporarily stored.

The storing unit 261 stores data indicating a change over time of glucose concentration calculated using an analytical curve on the basis of the measured current value.

The data-display instructing unit 299 causes the monitor (the display unit) 151 to display glucose concentration calculated by the computing unit 200, date and time when the glucose concentration is measured, conditions such as body temperature during the measurement, and the like.

The circuit unit (the detecting-unit driving unit) 400 controls driving of the detection unit 300 on the basis of a measurement condition set by operation of the operation unit 212 by the measurer, and maintains, for example, a difference of a voltage 600 mV between the working electrode 311 and the reference electrode 313. The difference serves as an applied voltage to the detection unit 300. Consequently, the circuit unit 400 electrolyzes hydrogen peroxide included in the sensing layer 320 to generate an electron. The circuit unit 400 acquires the electron as an amount of an electric current based on glucose concentration flowing between the working electrode 311 and the counter electrode 312.

Note that the circuit unit 400 may include noise removing means such as a lock-in amplifier. Consequently, it is possible to suppress noise in measuring a current value. Therefore, accuracy of the current value and glucose concentration obtained from the current value is improved.

Further, the circuit unit 400 acquires temperature in interstitial fluid near the electrodes 311 and 312 by driving the temperature sensor 350.

The computing unit 200 reads a computer program stored in the storing unit 261 to execute arithmetic processing. The computing unit 200 includes a glucose-concentration calculating unit 200A.

The glucose-concentration calculating unit 200A reads an analytical curve stored in the storing unit 261 and drives glucose concentration in the interstitial fluid on the basis of the current value and the temperature acquired in the circuit unit 400 according to the driving of the detection unit 300.

The glucose concentration calculated by the computing unit 200 is displayed on the monitor 151 according to the operation of the data-display instructing unit 299.

The measuring device 101 in this embodiment having the configuration explained above measures a shift (Δt) between an initial set temperature and a present environmental temperature in interstitial fluid (an environment) near the conductive layer 315 and current fluctuation width of fluctuation in a current value measured in the conductive layer 315 due to the shift (Δt). The measuring device 101 computes glucose concentration (the concentration of a measurement target substance) with the computing unit 200 using the measured current fluctuation width of the current value on the basis of an analytical curve representing a relation between the current fluctuation width of the current value and glucose concentration in the interstitial fluid in the shift (Δt) from the initial set temperature stored in the storing unit 261 in advance. In this way, the glucose concentration in the interstitial fluid is calculated using the current fluctuation width of the current value based on the shift (Δt) from the set temperature. Consequently, it is possible to measure glucose concentration at more excellent accuracy even if the temperature of body fluid near a place where a current value is measured fluctuates. A principle for this is explained below.

As shown in FIGS. 8 and 9, a current value measured in the conductive layer 315 has inherent magnitude of an electric current according to the concentration of glucose included in interstitial fluid. If the temperature (an environmental temperature) of interstitial fluid (an environment) near the conductive layer 315 is fixed, the magnitude does not change with time (in FIGS. 8 and 9, the glucose concentration is 100 mg/dL and 400 mg/dL).

As described in JP-A-2008-62072, the current value measured in the conductive layer 315 changes in a linear function manner according to an increase in the concentration of the glucose included in the interstitial fluid. Therefore, at a fixed temperature, a specific current value-glucose concentration profile represents a relation between the current value and the glucose concentration. Therefore, it is possible to specify the glucose concentration on the basis of the current value. For example, in FIG. 10, a current value-glucose concentration profile P1 represents a relation between a current value and glucose concentration at a fixed temperature (a first temperature) T1. As shown in FIG. 10, the profile P1 has a gradient S1.

However, it is known that the profile P1 changes according to a certain predictable method together with a temperature change. Specifically, it is known that, every time the temperature of the interstitial fluid near the conductive layer 315 rises 1° C. from T1, the gradient S1 increases by a certain specific amount (probably, becomes steeper 6% ever time the temperature rises 1° C.)

When this principle is applied, a relation between a current value and glucose concentration at second temperature T2 higher than the first temperature T1 is indicated by a current value-glucose concentration profile P2 shown in FIG. 10. In the profile P2, since the second temperature T2 is higher than the first temperature T1, a gradient S2 is larger than the gradient S1. Such a principle enables the magnitude of amplitude due to the glucose concentration to be read in FIG. 8.

That is, current fluctuation width of fluctuation in the current value measured in the conductive layer 315 changes according to the magnitude of a shift (Δt) between the first temperature (an initial set temperature) T1 and the second temperature (a present environmental temperature) T2. As shown in FIG. 11, the current fluctuation width also changes in a linear function manner according to the increase in the concentration of the glucose included in the interstitial fluid. Therefore, it is possible to derive glucose concentration in the interstitial fluid by measuring the magnitude of the shift (Δt) to the second temperature (the present environmental temperature) T2 from the first temperature (the initial set temperature) T1 and the current fluctuation width of the fluctuation of the current value measured in the conductive layer 315 and using, on the basis of the magnitude of the shift (Δt) and the current fluctuation width, an analytical curve shown in FIG. 11 prepared in advance, that is, an analytical curve representing a relation between the current fluctuation width of the current value and the concentration of the glucose in the interstitial fluid in the shift (Δt) from the first temperature (the initial set temperature) T1.

A plurality of the analytical curves are prepared assuming that the temperature of the interstitial fluid changes to a plurality of the second temperatures (the present environmental temperatures) T2 according to a plurality of the first temperatures (the initial set temperatures) T1, that is, the magnitudes of the shift (Δt) are different, the plurality of analytical curves are stored in the storing unit 261, and glucose concentration is derived by the computing unit 200 using the analytical curves corresponding to the first temperatures T1 and the shift (Δt). Then, it is possible to calculate glucose concentration at more excellent accuracy even if the temperature of body fluid near a place where a current value is measured fluctuates.

Note that the magnitude of the shift (Δt) caused because the temperature of the interstitial fluid changes to the second temperature (the present environmental temperature) T2 according to the first temperature (the initial set temperature) T1 is not particularly limited. However, the magnitude of the shift (Δt) is desirably set to 0.1° C. or more and 0.8° C. or less and more desirably set to 0.2° C. or more and 0.6° C. or less. Consequently, it is possible to calculate glucose concentration at more excellent concentration. It is possible to realistically detect the glucose concentration as the shift (Δt) that occurs in the interstitial fluid.

### Measuring Method

The measurement of the concentration of glucose in interstitial fluid using the measuring device 101 is specifically performed as explained below.

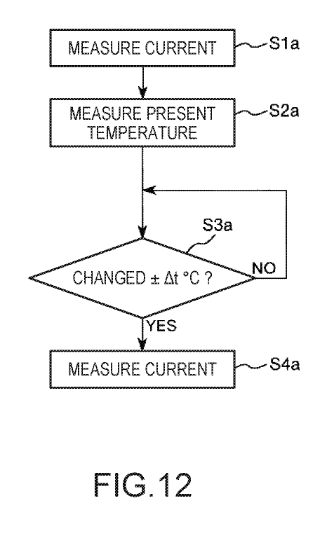

FIG. 12 is a flowchart for explaining a method of measuring glucose concentration using the measuring device shown in FIG. 1.

[1A] First, the measurer (a user) inserts the cannula 111 into the subcutaneous tissue 502 and sets the detection unit 300 (the sensing layer 320) in contact with interstitial fluid to stabilize the detection unit 300.

At this point, the measurer inputs, by operating the operation unit 212, measurement conditions such as the magnitude of the shift (Δt) of fluctuation of the temperature of the interstitial fluid near the conductive layer 315 from an initial set temperature (a present temperature measured in a post-process [4A]) and a period (time) in which glucose concentration is measured.

[2A] Subsequently, the control unit 210 operates the circuit unit 400 to apply a fixed voltage between the working electrode 311 and the reference electrode 313 for a predetermined length. Consequently, the control unit 210 electrolyzes, as indicated by Formula (2) described above, hydrogen peroxide generated near the working electrode 311 of the sensing layer 320 in the stabilization to initially set temperature near the working electrode 311 of the sensing layer 320.

[3A] Subsequently, after an interval of a fixed time, the control unit 210 operates the circuit unit 400 to apply a fixed voltage between the working electrode 311 and the reference electrode 313 for a predetermined length. Consequently, the hydrogen peroxide generated near the working electrode 311 of the sensing layer 320 is electrolyzed as indicated by Formula (2) described above. An electron generated as a result of the electrolysis is measured as a value of an electric current (a current value 1A) flowing between the working electrode 311 and the counter electrode 312 (S1a).

[4A] Subsequently, the control unit 210 operates the circuit unit 400 to measure, with the temperature sensor 350, temperature (a present temperature) in the interstitial fluid (the environment) near the conductive layer 315 (S2a).

The present temperature is temporarily stored in the storing unit 261 as an initial set temperature.

[5A] Subsequently, the control unit 210 continuously measures temperature (an environmental temperature) in the interstitial fluid (the environment) near the conductive layer 315 using the temperature sensor 350 according to the operation of the circuit unit 400. The control unit 210 carries out the continuous measurement until the magnitude of a shift, which is a difference between the measured temperature (environmental temperature) and the initial set temperature, reaches the magnitude of the shift (Δt) (S3a).

Note that the shift (Δt) may be +Δt meaning that the measured temperature is higher than the initial set temperature or may be −Δt meaning that the measured temperature is lower than the initial set temperature.

When the magnitude of the shift is ±Δt, the control unit 210 stops measuring the temperature of the interstitial fluid using the temperature sensor 350 according to the operation of the circuit unit 400. The control unit 210 operates the circuit unit 400 to measure a value of an electric current (a current value 2A) flowing between the working electrode 311 and the counter electrode 312 (S4a).

[6A] Subsequently, the control unit 210 operates the computing unit 200 (the glucose-concentration calculating unit 200A) to calculate, from the current value 1A and the current value 2A obtained in step [3A] and step [5A] described above, the absolute value of a difference between the current value 1A and the current value 2A, that is, current fluctuation width. Consequently, a fluctuation amount of the current value based on the concentration of the glucose included in the interstitial fluid is measured.

The glucose-concentration calculating unit 200A extracts, from the storing unit 261, an analytical curve corresponding to the initial set temperature measured in step [4A] described above and the magnitude of the shift (Δt) set in step [1A] described above and calculates the concentration of the glucose in the interstitial fluid from the obtained current fluctuation width using the analytical curve.

At this point, in the invention, analytical curves corresponding to the initial set temperature measured in step [4A] described above and the magnitude of the shift (Δt) set in step [1A] described above are stored in a plurality of storing units 261. Therefore, it is possible to surely calculate glucose concentration using the analytical curves respectively corresponding to the initial set temperature and the size of the shift (Δt). Therefore, the calculated glucose concentration has excellent accuracy.

[7A] Subsequently, the control unit 210 operates the computing unit 200 (the data-display instructing unit 299) to cause the monitor (the display unit) 151 to display the glucose concentration calculated in step [6A] described above.

Simultaneously with the display, the control unit 210 causes the storing unit 261 to store the glucose concentration according to necessity.

Note that step [3A] to step [6A] described above may be performed once. However, the glucose concentration is averaged by repeatedly performing step [3A] to step [6A] described above and calculating an average of glucose concentration measured during the repetition of the steps. Therefore, it is possible to calculate the glucose concentration at more excellent reliability.

By repeatedly performing step [3A] to step [7A] described above at a predetermined interval, it is possible to continuously measure the concentration of the glucose in the interstitial fluid.

### Second Embodiment

A second embodiment of the measuring device according to the invention is explained.

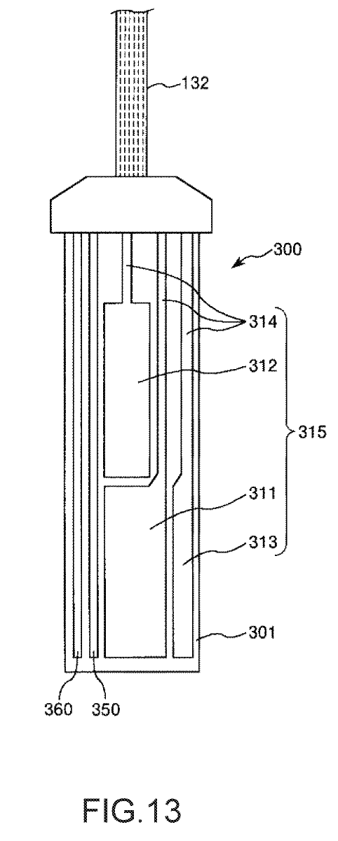

FIG. 13 is a plan view showing a detecting unit included in a detection element included in the second embodiment of the measuring device according to the invention.

In the following explanation, concerning the measuring device 101 in the second embodiment, differences from the measuring device 101 in the first embodiment are mainly explained. Explanation of similarities is omitted.

The measuring device 101 in the second embodiment is the same as the measuring device 101 in the first embodiment shown in FIGS. 1 to 7 except that the configuration of the detection unit 300 and the circuit second 400 shown in FIG. 13 and a measuring method for glucose concentration using the measuring device 101 are different.

That is, in the measuring device 101 in the second embodiment, the detection unit 300 includes a temperature adjusting unit 360 that adjusts temperature in interstitial fluid near the conductive layer 315. Further, the circuit unit 400 is configured to be capable of adjusting temperature in interstitial fluid near the electrodes 311 and 312 according to driving of the temperature adjusting unit 360.

The temperature adjusting unit 360 adjusts the temperature in the interstitial fluid near the conductive layer 315, that is, an environmental temperature of an environment in which the conductive layer 315 (the current measuring unit) is placed.

Like the temperature sensor 350 and the conductive layer 315, the temperature adjusting unit 360 is formed on the substrate 301. In this embodiment, the temperature adjusting unit 360 is provided near and on the lateral side of, in particular, the working electrode 311 and the counter electrode 312 in the conductive layer 315. The temperature adjusting unit 360 is covered with the sensing layer 320 together with the temperature sensor 350 and the conductive layer 315.

The temperature adjusting unit 360 is electrically connected to the circuit unit 400 including the computing unit 200 via the wire 132 and the connector 131. Consequently, by driving the temperature adjusting unit 360, it is possible to set, to a desired temperature, the temperature in the interstitial fluid near the conductive layer 315 in measuring a value of an electric current flowing between the electrodes 311 and 312.

As the temperature adjusting unit 360, for example, besides a Peltier element, publicly-known various elements can be used.

The Peltier element includes a closed circuit formed by PN-joining N-type and P-type semiconductors. The Peltier element is configured to be capable of switching the polarity of an electric current fed to the circuit. In the Peltier element capable of switching an electric current, when an electric current is fed to a PN junction section of the Peltier element, a heat absorbing phenomenon occurs in an N→P junction portion and a heat radiating phenomenon occurs in a P→N junction portion. Therefore, by using the heat absorbing phenomenon and the heat radiating phenomenon, it is possible to heat the interstitial fluid near the conductive layer 315 and cool the interstitial fluid near the conductive layer 315.

Since the detection unit 300 includes the temperature adjusting unit 360, it is possible to actively (positively) create fluctuation (a change) in the temperature in the interstitial fluid near the conductive layer 315. Therefore, it is possible to measure glucose concentration (data) more stably and in a shorter time.

### Measuring Method

The measurement of glucose concentration in interstitial fluid using the measuring device 101 in the second embodiment is specifically carried out by, for example, first to third methods explained blow. Note that, in the first method, temperature (an environmental temperature) in the interstitial fluid near the conductive layer 315 is raised to be higher than the initial set temperature to cause a shift (+Δt), in the second method, the temperature (the environmental temperature) in the interstitial fluid near the conductive layer 315 is reduced to be lower than the initial set temperature to cause a shift (−Δt), and in the third method, the temperature (the environmental temperature) in the interstitial fluid near the conductive layer 315 is raised to be higher than the initial set temperature by heating the interstitial fluid to cause the shift (+Δt) and thereafter the temperature (the environmental temperature) in the interstitial fluid near the conductive layer 315 is reduced to be lower than the initial set temperature by cooling the interstitial fluid to cause the shift (−Δt).

### First Method

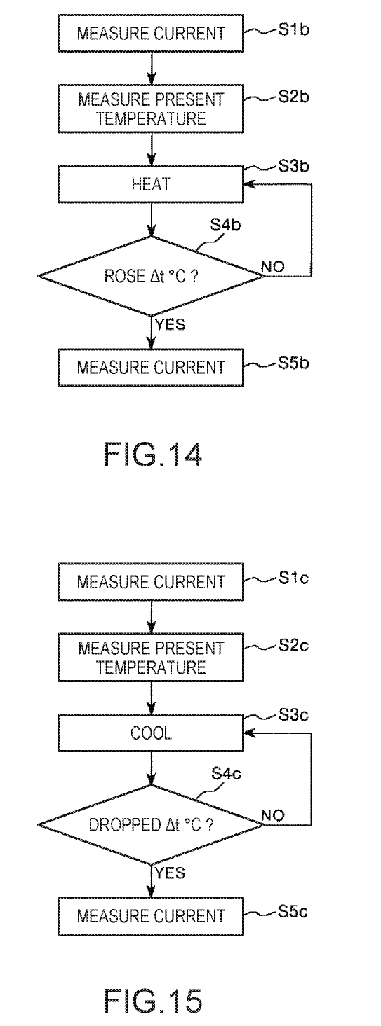

FIG. 14 is a flowchart for explaining the first method of measuring glucose concentration using the measuring device shown in FIG. 13.

[1B] First, the measurer (the user) inserts the cannula 111 into the subcutaneous tissue 502 and sets the detection unit 300 (the sensing layer 320) in contact with interstitial fluid to stabilize the detection unit 300.

At this point, the measurer inputs, by operating the operation unit 212, measurement conditions such as the magnitude of the shift (Δt) of fluctuation of the temperature of the interstitial fluid near the conductive layer 315 from an initial set temperature (a present temperature measured in a post-process [4B]) and a period (time) in which glucose concentration is measured.

[2B] Subsequently, the control unit 210 operates the circuit unit 400 to apply a fixed voltage between the working electrode 311 and the reference electrode 313 for a predetermined length. Consequently, the control unit 210 electrolyzes, as indicated by Formula (2) described above, hydrogen peroxide generated near the working electrode 311 of the sensing layer 320 in the stabilization to initially set temperature near the working electrode 311 of the sensing layer 320.

[3B] Subsequently, after an interval of a fixed time, the control unit 210 operates the circuit unit 400 to apply a fixed voltage between the working electrode 311 and the reference electrode 313 for a predetermined length. Consequently, the hydrogen peroxide generated near the working electrode 311 of the sensing layer 320 is electrolyzed as indicated by Formula (2) described above. An electron generated as a result of the electrolysis is measured as a value of an electric current (a current value 1B) flowing between the working electrode 311 and the counter electrode 312 (S1b).

[4B] Subsequently, the control unit 210 operates the circuit unit 400 to measure, with the temperature sensor 350, temperature (a present temperature) in the interstitial fluid near the conductive layer 315 (S2b).

The present temperature is temporarily stored in the storing unit 261 as an initial set temperature.

[5B] Subsequently, the control unit 210 heats, by operating the circuit unit 400, the interstitial fluid near the conductive layer 315 using the temperature adjusting unit 360 to raise temperature (an environmental temperature) in the interstitial fluid (S3b).

Simultaneously with heating the interstitial fluid using the temperature adjusting unit 360, the control unit 210 continuously measures the temperature (the environmental temperature) in the interstitial fluid near the conductive layer 315 using the temperature sensor 350 according to the operation of the circuit unit 400. The control unit 210 carries out the continuous measurement until the magnitude of a shift, which is a difference between the measured temperature (environmental temperature) and the initial set temperature, reaches the magnitude of the shift (+Δt) (S4b).

Thereafter, when the magnitude of the shift reaches +Δt, the control unit 210 stops measuring the temperature of the interstitial fluid using the temperature sensor 350 according to the operation of the circuit unit 400 and stops heating the interstitial fluid using the temperature adjusting section 360 according to the operation of the circuit unit 400. The control unit 210 operates the circuit unit 400 to measure a value of an electric current (a current value 2B) flowing between the working electrode 311 and the counter electrode 312 (S5b).

[6B] Subsequently, the control unit 210 operates the computing unit 200 (the glucose-concentration calculating unit 200A) to calculate, from the current value 1B and the current value 2B obtained in step [3B] and step [5B] described above, the absolute value of a difference between the current value 1B and the current value 2B, that is, current fluctuation width.

The glucose-concentration calculating unit 200A extracts, from the storing unit 261, an analytical curve corresponding to the initial set temperature measured in step [4B] described above and the magnitude of the shift (+Δt) set in step [1B] described above and calculates the concentration of the glucose in the interstitial fluid from the obtained current fluctuation width using the analytical curve.

[7B] Subsequently, the control unit 210 operates the computing unit 200 (the data-display instructing unit 299) to cause the monitor (the display unit) 151 to display the glucose concentration calculated in step [6B] described above.

Simultaneously with the display, the control unit 210 causes the storing unit 261 to store the glucose concentration according to necessity.

Note that step [3B] to step [6B] described above may be performed once. However, the glucose concentration is averaged by repeatedly performing step [3B] to step [6B] described above and calculating an average of glucose concentration measured during the repetition of the steps. Therefore, it is possible to calculate the glucose concentration at more excellent reliability.

By repeatedly performing step [3B] to step [7B] described above at a predetermined interval, it is possible to continuously measure the concentration of the glucose in the interstitial fluid.

### Second Method

FIG. 15 is a flowchart for explaining the second method of measuring glucose concentration using the measuring device shown in FIG. 13.

[1C] First, the measurer (the user) inserts the cannula 111 into the subcutaneous tissue 502 and sets the detection unit 300 (the sensing layer 320) in contact with interstitial fluid to stabilize the detection unit 300.

At this point, the measurer inputs, by operating the operation unit 212, measurement conditions such as the magnitude of the shift (Δt) of fluctuation of the temperature of the interstitial fluid near the conductive layer 315 from an initial set temperature (a present temperature measured in a post-process [4C]) and a period (time) in which glucose concentration is measured.

[2C] Subsequently, the control unit 210 operates the circuit unit 400 to apply a fixed voltage between the working electrode 311 and the reference electrode 313 for a predetermined length. Consequently, the control unit 210 electrolyzes, as indicated by Formula (2) described above, hydrogen peroxide generated near the working electrode 311 of the sensing layer 320 in the stabilization to initially set temperature near the working electrode 311 of the sensing layer 320.

[3C] Subsequently, after an interval of a fixed time, the control unit 210 operates the circuit unit 400 to apply a fixed voltage between the working electrode 311 and the reference electrode 313 for a predetermined length. Consequently, the hydrogen peroxide generated near the working electrode 311 of the sensing layer 320 is electrolyzed as indicated by Formula (2) described above. An electron generated as a result of the electrolysis is measured as a value of an electric current (a current value 1C) flowing between the working electrode 311 and the counter electrode 312 (S1c).

[4C] Subsequently, the control unit 210 operates the circuit unit 400 to measure, with the temperature sensor 350, temperature (a present temperature) in the interstitial fluid near the conductive layer 315 (S2c).

The present temperature is temporarily stored in the storing unit 261 as an initial set temperature.

[5C] Subsequently, the control unit 210 cools, by operating the circuit unit 400, the interstitial fluid near the conductive layer 315 using the temperature adjusting unit 360 to drop temperature (an environmental temperature) in the interstitial fluid (S3c).

Simultaneously with cooling the interstitial fluid using the temperature adjusting unit 360, the control unit 210 continuously measures the temperature (the environmental temperature) in the interstitial fluid near the conductive layer 315 using the temperature sensor 350 according to the operation of the circuit unit 400. The control unit 210 carries out the continuous measurement until the magnitude of a shift, which is a difference between the measured temperature (environmental temperature) and the initial set temperature, reaches the magnitude of the shift (−Δt) (S4c).

Thereafter, when the magnitude of the shift reaches −Δt, the control unit 210 stops the measurement of the temperature of the interstitial fluid using the temperature sensor 350 and the cooling of the interstitial fluid using the temperature adjusting unit 360 according to the operation of the circuit unit 400. The control unit 210 operates the circuit unit 400 to measure a value of an electric current (a current value 2C) flowing between the working electrode 311 and the counter electrode 312 (S5c).

[6C] Subsequently, the control unit 210 operates the computing unit 200 (the glucose-concentration calculating unit 200A) to calculate, from the current value 1C and the current value 2C obtained in step [3C] and step [5C] described above, the absolute value of a difference between the current value 1C and the current value 2C, that is, current fluctuation width.

The glucose-concentration calculating unit 200A extracts, from the storing unit 261, an analytical curve corresponding to the initial set temperature measured in step [4C] described above and the magnitude of the shift (+Δt) set in step [1C] described above and calculates the concentration of the glucose in the interstitial fluid from the obtained current fluctuation width using the analytical curve.

[7C] Subsequently, the control unit 210 operates the computing unit 200 (the data-display instructing unit 299) to cause the monitor (the display unit) 151 to display the glucose concentration calculated in step [6C] described above.

Simultaneously with the display, the control unit 210 causes the storing unit 261 to store the glucose concentration according to necessity.

Note that step [3C] to step [6C] described above may be performed once. However, the glucose concentration is averaged by repeatedly performing step [3C] to step [6C] described above and calculating an average of glucose concentration measured during the repetition of the steps. Therefore, it is possible to calculate the glucose concentration at more excellent reliability.

By repeatedly performing step [3C] to step [7C] described above at a predetermined interval, it is possible to continuously measure the concentration of the glucose in the interstitial fluid.

### Third Method

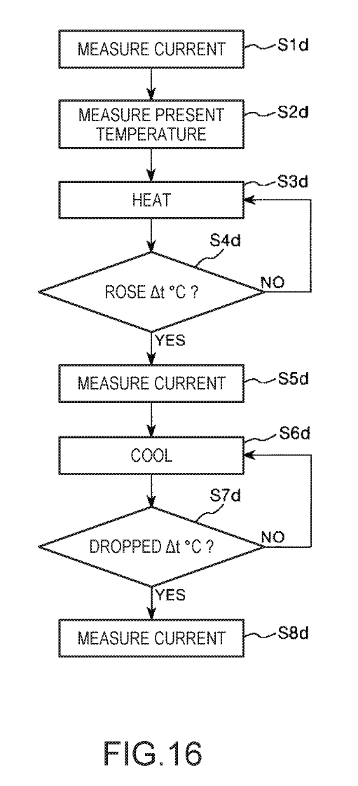

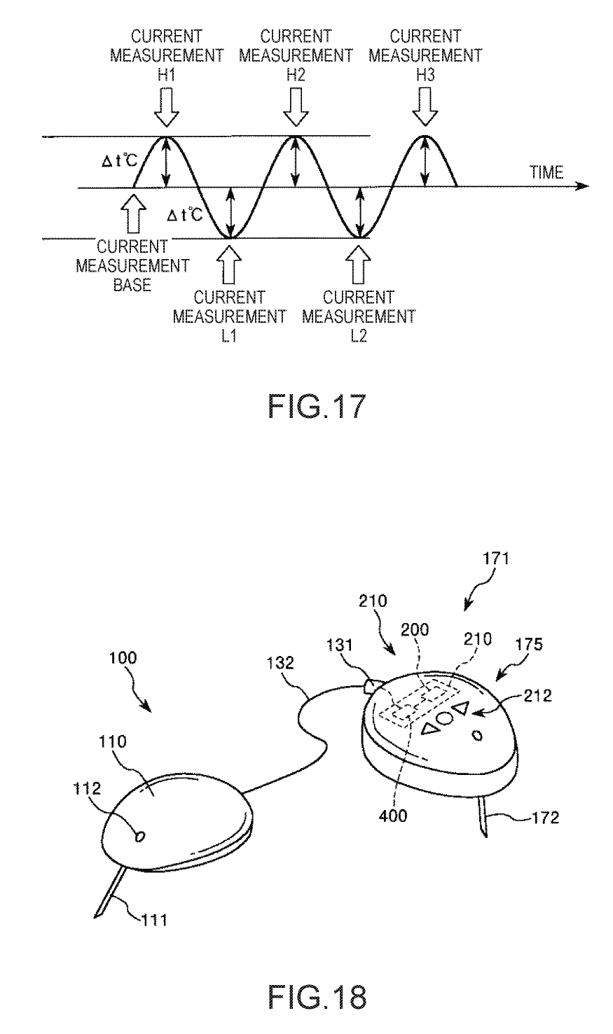

FIG. 16 is a flowchart for explaining a third method of measuring glucose concentration using the measuring device shown in FIG. 13. FIG. 17 is a graph showing a relation between the temperature of interstitial fluid at the time when glucose concentration is measured using the third method shown in FIG. 16 and time.

[1D] First, the measurer (the user) inserts the cannula 111 into the subcutaneous tissue 502 and sets the detection unit 300 (the sensing layer 320) in contact with interstitial fluid to stabilize the detection unit 300.

At this point, the measurer inputs, by operating the operation unit 212, measurement conditions such as the magnitude of the shift (Δt) of fluctuation of the temperature of the interstitial fluid near the conductive layer 315 from an initial set temperature (a present temperature measured in a post-process [4D]) and a period (time) in which glucose concentration is measured.

[2D] Subsequently, the control unit 210 operates the circuit unit 400 to apply a fixed voltage between the working electrode 311 and the reference electrode 313 for a predetermined length. Consequently, the control unit 210 electrolyzes, as indicated by Formula (2) described above, hydrogen peroxide generated near the working electrode 311 of the sensing layer 320 in the stabilization to initially set temperature near the working electrode 311 of the sensing layer 320.

[3D] Subsequently, after an interval of a fixed time, the control unit 210 operates the circuit unit 400 to apply a fixed voltage between the working electrode 311 and the reference electrode 313 for a predetermined length. Consequently, the hydrogen peroxide generated near the working electrode 311 of the sensing layer 320 is electrolyzed as indicated by Formula (2) described above. An electron generated as a result of the electrolysis is measured as a value of an electric current (a current value 1D) flowing between the working electrode 311 and the counter electrode 312 (S1d).

[4D] Subsequently, the control unit 210 operates the circuit unit 400 to measure, with the temperature sensor 350, temperature (a present temperature) in the interstitial fluid near the conductive layer 315 (S2d).

The present temperature is temporarily stored in the storing unit 261 as an initial set temperature.

[5D] Subsequently, the control unit 210 heats, by operating the circuit unit 400, the interstitial fluid near the conductive layer 315 using the temperature adjusting unit 360 to raise temperature (an environmental temperature) in the interstitial fluid (S3d). That is, the control unit 210 gradually increases the temperature of the interstitial fluid.

Simultaneously with heating the interstitial fluid using the temperature adjusting unit 360, the control unit 210 continuously measures the temperature (the environmental temperature) in the interstitial fluid near the conductive layer 315 using the temperature sensor 350 according to the operation of the circuit unit 400. The control unit 210 carries out the continuous measurement until the magnitude of a shift, which is a difference between the measured temperature (environmental temperature) and the initial set temperature, reaches the magnitude of the shift (+Δt) (S4d).

Thereafter, when the magnitude of the shift reaches +Δt, the control unit 210 stops the measurement of the temperature of the interstitial fluid using the temperature sensor 350 and the heating of the interstitial fluid using the temperature adjusting unit 360 according to the operation of the circuit unit 400. The control unit 210 operates the circuit unit 400 to measure a value of an electric current (a current value 2D) flowing between the working electrode 311 and the counter electrode 312 (S5d).

[6D] Subsequently, the control unit 210 cools, by operating the circuit unit 400, the interstitial fluid near the conductive layer 315 using the temperature adjusting unit 360 to drop temperature (an environmental temperature) in the interstitial fluid (S6d). That is, the control unit 210 gradually reduces the temperature of the interstitial fluid.

Simultaneously with cooling the interstitial fluid using the temperature adjusting unit 360, the control unit 210 continuously measures the temperature (the environmental temperature) in the interstitial fluid near the conductive layer 315 using the temperature sensor 350 according to the operation of the circuit unit 400. The control unit 210 carries out the continuous measurement until the magnitude of a shift, which is a difference between the measured temperature (environmental temperature) and the initial set temperature, reaches the magnitude of the shift (−Δt) (S7d).

Thereafter, when the magnitude of the shift reaches −Δt, the control unit 210 stops the measurement of the temperature of the interstitial fluid using the temperature sensor 350 and the cooling of the interstitial fluid using the temperature adjusting unit 360 according to the operation of the circuit unit 400. The control unit 210 operates the circuit unit 400 to measure a value of an electric current (a current value 3D) flowing between the working electrode 311 and the counter electrode 312 (S8d).

[7D] Subsequently, the control unit 210 operates the computing unit 200 (the glucose-concentration calculating unit 200A) to calculate, from the current value 1D and the current value 2D obtained in step [3D] and step [5D] described above, the absolute value of a difference between the current value 1D and the current value 2D, that is, current fluctuation width.

The glucose-concentration calculating unit 200A extracts, from the storing unit 261, an analytical curve corresponding to the initial set temperature measured in step [4D] described above and the magnitude of the shift (+Δt) set in step [1D] described above and calculates the concentration of the glucose in the interstitial fluid (glucose concentration 1D) from the obtained current fluctuation width using the analytical curve.

Further, the control unit 210 operates the computing unit 200 (the glucose-concentration calculating unit 200A) to calculate, from the current value 1D and the current value 3D obtained in step [3D] and step [6D] described above, the absolute value of a difference between the current value 1D and the current value 3D, that is, current fluctuation width.

The glucose-concentration calculating unit 200A extracts, from the storing unit 261, an analytical curve corresponding to the initial set temperature measured in step [4D] described above and the magnitude of the shift (−Δt) set in step [1D] described above and calculates the concentration of the glucose (glucose concentration 2D) in the interstitial fluid from the obtained current fluctuation width using the analytical curve.

The glucose-concentration calculating unit 200A calculates an average of the calculated glucose concentration (an average of the glucose concentration 1D and the glucose concentration 2D) to obtain glucose concentration in this embodiment. In this way, in the third method, the glucose concentration (the average of the glucose concentration) is calculated using the glucose concentration 1D and the glucose concentration 2D calculated from the analytical curve based on the shift (+Δt) obtained by gradually increasing the temperature of the interstitial fluid (heating the interstitial fluid) and the analytical curve based on the shift (−Δt) obtained by gradually reducing the temperature of the interstitial fluid (cooling the interstitial fluid). That is, the glucose concentration (the average of the glucose concentration) is acquired using the glucose concentration 1D and the glucose concentration 2D acquired according a plurality of conditions. Therefore, it is possible to calculate the glucose concentration (the average of the glucose concentration) as glucose concentration having more excellent accuracy.

[8D] Subsequently, the control unit 210 operates the computing unit 200 (the data-display instructing unit 299) to cause the monitor (the display unit) 151 to display the glucose concentration (the average of the glucose concentration) obtained in step [6D] described above.

Simultaneously with the display, the control unit 210 causes the storing unit 261 to store the glucose concentration according to necessity.

Note that step [3D] to step [7D] described above may be performed once. However, as shown in FIG. 17, the glucose concentration is further averaged by repeatedly performing step [3D] to step [7D] described above and calculating an average of glucose concentration measured during the repetition of the steps. Therefore, it is possible to calculate the glucose concentration at more excellent reliability.

Note that the temperature in the interstitial fluid near the conductive layer 315 does not need to forma sine curve as shown in FIG. 17. The heating (the gradual increase) and the cooling (the gradual reduction) only have to be repeatedly performed. The heating (the gradual increase) and the cooling (the gradual reduction) do not need to be performed at a fixed interval. The heating and the cooling only have to be alternately performed at a desired interval.

By repeatedly performing step [3D] to step [8D] described above at a predetermined interval, it is possible to continuously measure the concentration of the glucose in the interstitial fluid.

### Insulin Pump

The invention is applied to a supply device (an insulin supply device) such as an insulin pump besides being applied to the measuring device explained above.

FIG. 18 is a perspective view schematically showing an embodiment in which the supply device according to the invention is applied to the insulin pump and shows a state in which a detachable unit included in a detection element included in the insulin pump is detached from the main body unit.

An insulin pump 171 shown in FIG. 18 is used with the detection element 100 connected thereto. The insulin pump 171 includes the detection element 100, the control unit 210 including the circuit unit 400 for obtaining a current value based on glucose concentration in the detection element 100 and the computing unit 200 that calculates the glucose concentration on the basis of the obtained current value, a supply unit (a chemical supplying unit) 175 including a needle section 172 that supplies (administers) insulin to the subcutaneous tissue 502 on the basis of a measurement value (the concentration of a measurement target substance) obtained by computation in the control unit 210, the operation unit 212 for performing kinds of operation such as an input, the connector 131 that connects the detection element 100 to the control unit 210, and the wire 132 that connects the detection element 100 and the connector 131.

That is, the insulin pump 171 has a configuration same as the configuration of the measuring device 101 except that the insulin pump 171 includes the supply unit 175 instead of the monitor 151 included in the measuring device 101.

In such an insulin pump 171, a value of an electric current flowing between the working electrode 311 and the counter electrode 312 is detected by the circuit unit 400 via the wire 132 and the connector 131. The current value is transmitted to the computing unit 200 included in the control unit 210. The concentration of glucose (glucose concentration) in interstitial fluid is calculated as a measurement value according to an analysis of the computing unit 200. The insulin pump 171 operates on the basis of the measurement value (the glucose concentration), that is, when the measurement value is higher than set concentration. Insulin (chemical) is automatically administered to a wearer via the needle section 172.

The measuring device, the measuring method, and the supply device according to the invention are explained above with reference to the embodiments shown in the figures. However, the invention is not limited to this.

For example, the components of the units in the measuring device and the supply device according to the invention can be replaced with any components having the same functions. Any other components may be added to the invention. The invention may be a combination of any two or more components (characteristics) of the measuring device and the supply device.

The cannula may be inserted into the skin besides being inserted into the subcutaneous tissue.

Further, in the measuring device and the supply device, the current value detected by the detection element may be transmitted to a processing circuit not via a wire. For example, the current value may be transmitted to the processing circuit by radio via communicating means.

In the measuring device, the detection element and the display unit are not limited to be connected via the wire and may be integrally formed. In the supply device, the detection element and the supply unit are not limited to be connected via the wire and may be integrally formed.

The entire disclosure of Japanese Patent Application No. 2015-249401 filed Dec. 22, 2015 is expressly incorporated by reference herein.

What is claimed is:

1. A measuring device comprising:
a current measuring unit configured to measure a value of an electric current that fluctuates according to concentration of a measurement target substance;
a temperature measuring unit configured to measure an environmental temperature of an environment in which the current measuring unit is placed;
a storing unit configured to store, as a plurality of combinations, analytical curves of current fluctuation width due to a shift (Δt) of the environmental temperature from a set temperature and the concentration of the measurement target substance; and
a computing unit configured to derive the concentration of the measurement target substance from the shift (Δt) of the environmental temperature from the set temperature, the current value, and the analytical curves.

2. The measuring device according to claim 1, further comprising a temperature adjusting unit configured to adjust the environmental temperature.

3. The measuring device according to claim 1, wherein the plurality of combinations of the analytical curves are acquired according to a plurality of conditions for gradually increasing or reducing the environmental temperature.

4. The measuring device according to claim 1, wherein
the measurement target substance is glucose,
hydrogen peroxide is generated from the glucose by enzyme reaction, and
the electric current is an electric current generated by decomposing the hydrogen peroxide.

5. A measuring method comprising:
measuring a value of an electric current that fluctuates according to concentration of a measurement target substance;
measuring an environmental temperature of an environment in which the current value is measured; and
deriving the concentration of the measurement target substance from a plurality of combinations of analytical curves of current fluctuation width due to a shift (Δt) of the environmental temperature from a set temperature and the concentration of the measurement target substance, the environmental temperature, and the current value.

6. The measuring method according to claim 5, further comprising adjusting the environmental temperature before the current measurement or after the current measurement.

7. The measuring method according to claim 5, wherein the plurality of combinations of the analytical curves are acquired according to a plurality of conditions for gradually increasing or reducing the environmental temperature.

8. The measuring method according to claim 5, wherein
the measurement target substance is glucose,
hydrogen peroxide is generated from the glucose by enzyme reaction, and
the electric current is an electric current generated by decomposing the hydrogen peroxide.

9. A supply device comprising:
a current measuring unit configured to measure a value of an electric current that fluctuates according to concentration of a measurement target substance;
a temperature measuring unit configured to measure an environmental temperature of an environment in which the current measuring unit is placed;
a storing unit configured to store, as a plurality of combinations, analytical curves of current fluctuation width due to a shift (Δt) of the environmental temperature from a set temperature and the concentration of the measurement target substance;
a computing unit configured to derive the concentration of the measurement target substance from the environmental temperature, the current value, and the analytical curves; and
a chemical supplying unit configured to supply a chemical on the basis of the concentration of the measurement target substance.

10. The supply device according to claim 9, further comprising a temperature adjusting unit configured to adjust the environmental temperature.

11. The supply device according to claim 9, wherein the plurality of combinations of the analytical curves are acquired according to a plurality of conditions for gradually increasing or reducing the environmental temperature.

12. The supply device according to claim 9, wherein
the measurement target substance is glucose,
hydrogen peroxide is generated from the glucose by enzyme reaction,
the electric current is an electric current generated by decomposing the hydrogen peroxide, and
the chemical is insulin.
